(19) United States
(12) Patent Application Publication
(10) Pub. No.: US 2008/0103784 A1
(43) Pub. Date: May 1, 2008

(54) METHOD AND SYSTEM FOR CONSTRUCTING AN INTERACTIVE ONLINE NETWORK OF LIVING AND NON-LIVING ENTITIES

(75) Inventors: June T.W. Wong, Vancouver (CA); Clement K.L. Ma, Vancouver (CA)

Correspondence Address: OYEN, WIGGS, GREEN & MUTALA LLP;480 - THE STATION, 601 WEST CORDOVA STREET, VANCOUVER, BC, V6B 1G1, US

(73) Assignee: 0752004 B.C. Ltd., Vancouver (CA)

(21) Appl. No.: 11/552,933

(22) Filed: Oct. 25, 2006

(51) Int. Cl. G06Q 10/00; G06Q 30/00

(52) U.S. Cl. 705/1

(57) ABSTRACT

A method and system for generating an interactive computerized biological network consisting of living and non-living entities based upon the multiple relationship types which can exist between entities. The network can consist of multiple node types. Such node types can include persons, places, objects, and animals, each connected by one or more linkages associated with a precise linkage type representing the relationship type between a node and any other node type in the same network. Nodes are connected to other nodes in the network by linkages which can have multiple linkage types. Each linkage type represents the actual relationship type between the nodes, such as person, place, object or animal represented by the nodes.

### TECHNICAL FIELD

The invention relates to the field of online networks and more particularly to a method of constructing an interactive online network of living and non-living entities.

### BACKGROUND

The present inventors have disclosed in co-pending U.S. patent application Ser. No. 11/382,430 filed May 9, 2006, which is incorporated herein by reference, a method of constructing a family tree using an online social network. Such a family tree includes familial relationships among living and deceased individuals. However, there are many other types of relationships which can be documented between individuals, and furthermore there are many interactions between individuals and objects and other entities around them. At present there is no method to organize, display and precisely document the complex interactions between people and the many entities they encounter in their lives. There are many other such interactions in the real world other than those between persons, such as person to object, object to object, person to pet, pet to product, pet to pet, product owner to product, customer to business etc.

Online social networking systems such as Myspace.com and Friendster.com have recently become popular as a means to connect with and share personal information with other individuals via the Internet. Such social networks are based on users registering with the system and connecting with others on the system as friends. An individual establishes a home page on the network at which his/her friends can share photos, blogs, video files and the like. Such systems are limited to establishing symmetric connections between persons or organizations of persons, such as friendship relationships, and are not suited for including the wide variety of living and non-living entities with which a living individual interacts on a daily basis. Further, such systems do not construct a well-defined interactive structure of symmetric and asymmetric relationships among living and/or non-living entities which can be viewed and searched.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method and system for constructing an interactive computerized network of living and non-living entities, comprising: i) providing an interactive computer system comprising a database, the system being accessible to one or more users; ii) creating an interactive computerized network comprising a plurality of nodes, each node associated with a defined node type representing living and non-living entities, each node linked to one or more nodes of the same node type or a different node type by linkages; each linkage associated with a defined linkage type; each linkage type representing the type of relationship which exists between the entities represented by the nodes that are linked, the linkages of nodes thereby forming a computerized network.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating a computer network as used in the invention;

FIG. 2 is a schematic diagram illustrating a network of living and non-living entities as constructed according to the invention;

FIG. 3 illustrates a hierarchy of possible node types and sub-types; and

FIG. 4 illustrates a matrix of possible node linkage types;

FIG. 5 is a flowchart illustrating one aspect of the invention involving construction of a network, namely the steps in creating a new node;

FIG. 6 is a flowchart illustrating a second aspect of the invention involving construction of a network, namely the steps in creating a new node and creating a linkage from a new node to existing nodes; and

FIG. 7 is a flowchart illustrating a second aspect of the invention involving construction and modification of a network, namely the steps in creating or editing a linkage between two existing nodes.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

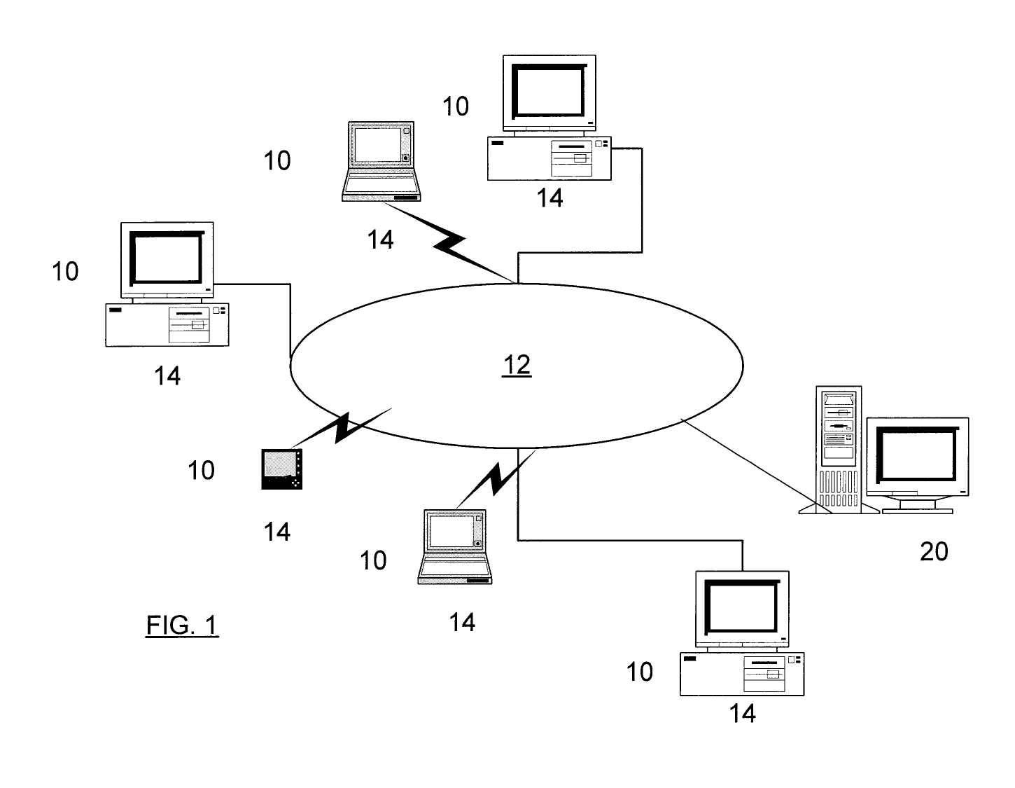

With reference to FIG. 1, a number of users 10 having computer terminals 14, whether laptops, desktops, handheld, personal digital assistants, mobile telephones or any other device capable of communicating over a network, have access to a computer network 12 such as the Internet, whether wirelessly or through wired access. Terminals 14 may have an internet browser and an e-mail application for example, and may themselves include a local or wide area network. A social network server or servers 20 maintain a system comprising an Internet website, database and associated data, which is accessible to users 10. Server 20 has the hardware and software required to operate an internet-accessible social network, including web server, email server, databases, data storage and the like.

Initially user 10 accesses the system website and is presented with a page to register for the system by entering basic profile information, such as name, gender, address, birthdate and a username and password. A unique identifier, such as a number, alphanumeric or alphabetic string, is assigned to the user and, once registered, a representation in the system, hereinafter referred to as a “node” 30, is created for the user. All of the foregoing are carried out in a manner well known to web site programmers. Such first node 31 is designated “active” as defined below.

Each active node can contain information pertaining to the living individual person that it represents, communication tools, data and files, storage space, network information and tools to edit the network of living and non-living entities. Nodes can contain genetic information. Each active node allows the individual person that it represents to log into the system and access its own node and its associated “control panel”. The user can upon registration and thereafter, carry out a number of tasks or activities while at the “control panel” of his/her node, including 1) edit his/her own node; 2) build a network of living and non-living entities (hereinafter “the network”); 3) edit the network; 4) communicate with other entities within or outside the network using the features of the social network; and 5) make use of projects and features facilitated by the network of living and non-living entities. As described further below, the control panel allows an individual person to i) expand and edit the network of living and non-living entities by: adding nodes and linkages; editing nodes and linkages; inviting other individual persons to join; and ii) communicate with nodes in the same network of living and non-living entities, other nodes in the computerized network, as well as other living individual persons outside the network of living and non-living entities; send invitations; accept invitations; grant permissions; share information; compare information; and make use of the projects and features facilitated by the network of living and non-living entities.

### Editing the User's Node

The user can edit the user's own node including editing the content of the user's profile, the appearance of the node, selecting the layout and color of the user's web page which is accessible to others, add, remove or edit photos, add or change privacy settings, add a blog or testimonials, add genetic information and the like. This can be done on registration and at any other time through the user's control panel.

### Constructing the Network of Living and Non-Living Entities

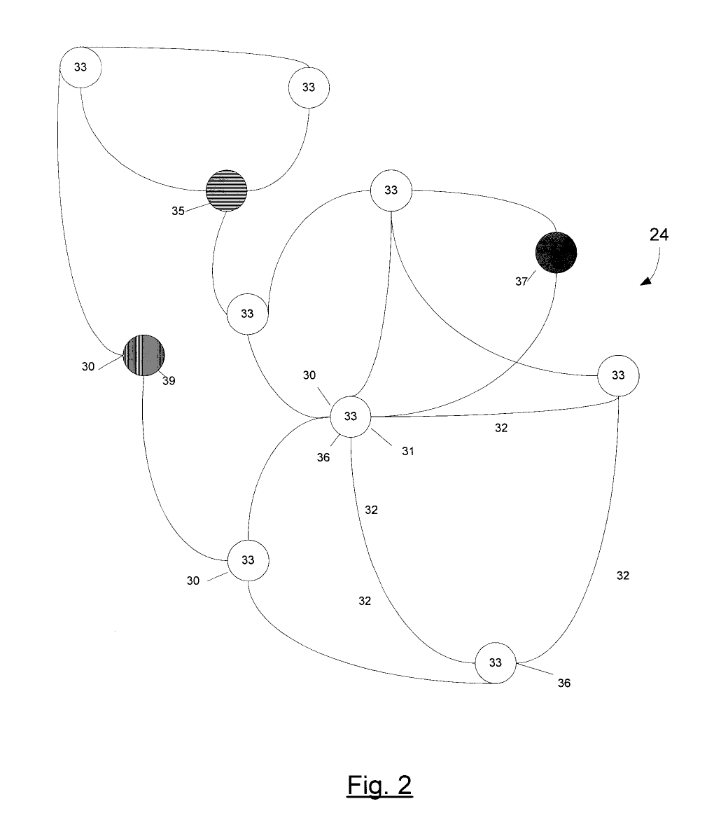

Once registered with the system, a user may start construction of his/her network of living and non-living entities 24 (FIG. 2). The network of living and non-living entities is represented by a number of elements, each representing a living or non-living entity, which are referred to as “nodes” 30, joined by connections 32, referred to as “linkages”, to other nodes 30. “Linkage” refers to the direct link between two adjacent nodes or the chain of links and nodes between non-adjacent nodes. The user, 31, can construct a network or join an existing network by adding, creating and linking new nodes 30 or by linking existing nodes, wherein nodes 30 represent people 33 (living and deceased), places 35, objects 37 and animals 39. Each time a node is added, that node is assigned a unique identifier, the nodes and their linkages thereby forming a network of living and non-living entities.

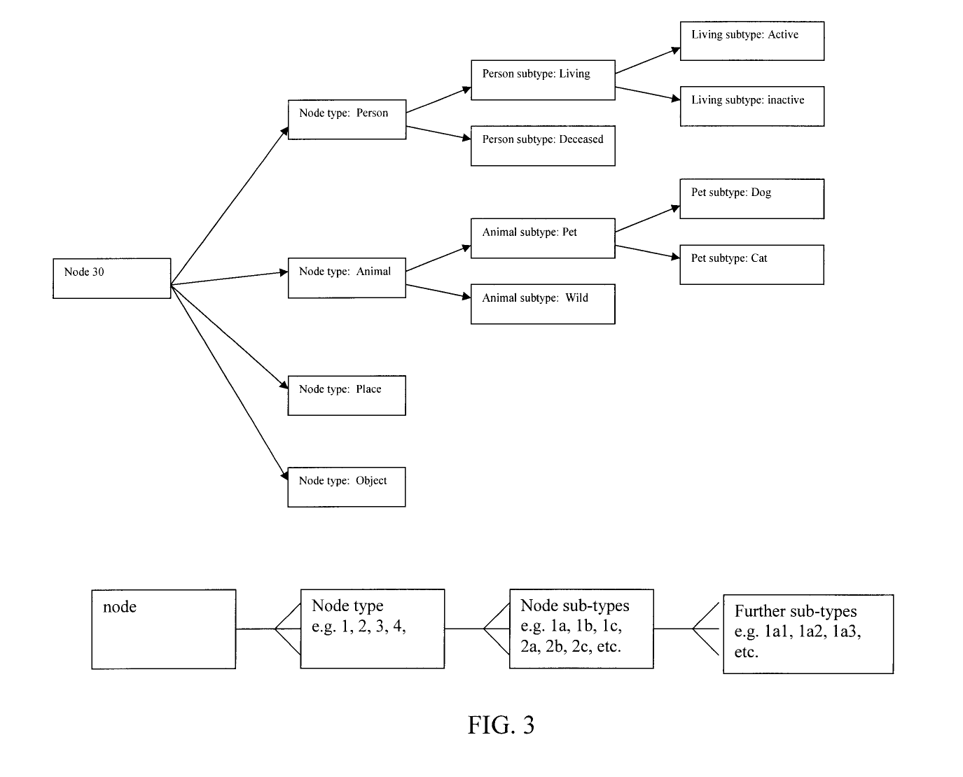

FIG. 3 illustrates the hierarchy of node types and sub-types. While four main node types are preferred, the number of main node types may be greater or less. For each main node type there are multiple sub-types or designations, and each sub-type can have sub-types etc. For example the person node type has sub-types living or deceased. The living sub-type has further sub-types active and inactive and so on. Further sub-types can include male/female, mother/father, etc. The animal node type has sub-types pet or wild animal. The pet sub-type has further sub-types dog/cat and so on. Object sub-types can be groups, organizations, products, businesses, books, songs, etc. Place sub-types can be country, state, province, city, town, landmark etc. Each node can be viewed by the user or third parties as a web page having features designated by the user it represents. Thus the network simultaneously consists of multiple nodes having designated types, sub-types, and further sub-types etc. co-existing in the same network.

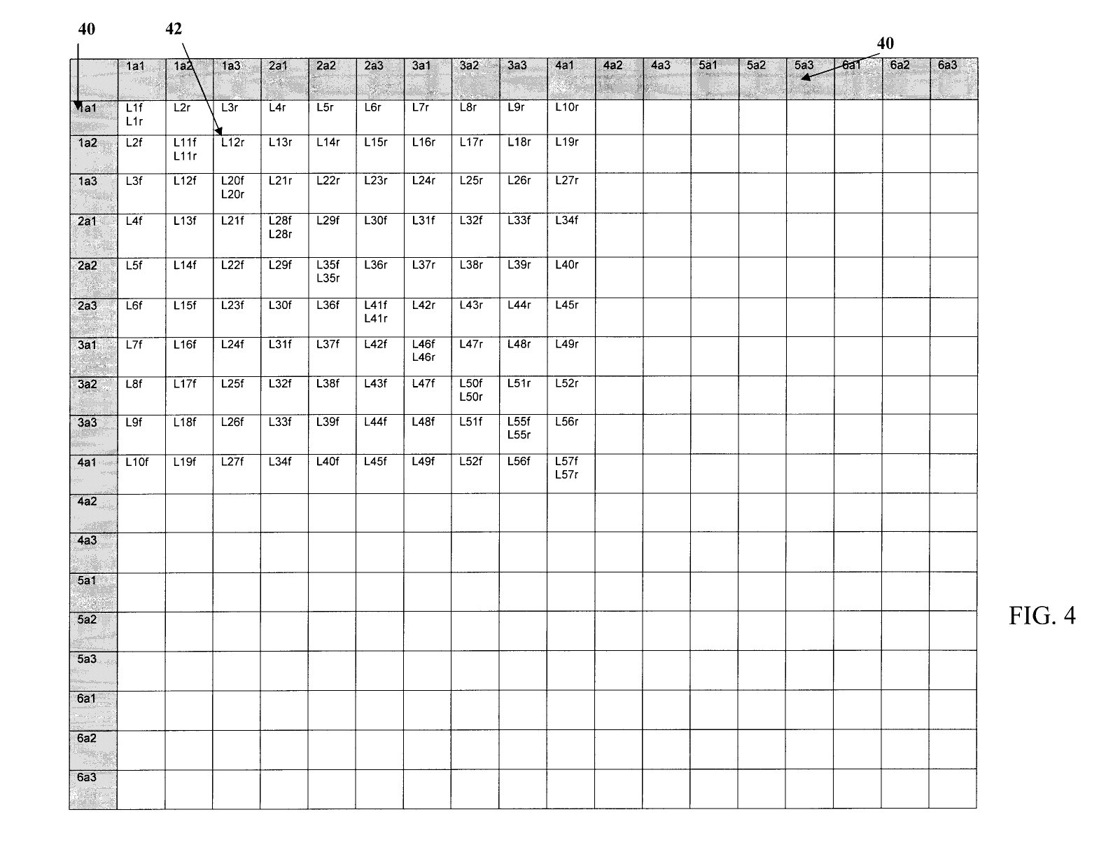

Each node type/sub-type has a defined structure and features, and common node types/sub-types have a common defined structure and features. Different node types/sub-types can have different properties, structure and features. Each node type/sub-type can be linked to any other node of the same node type/sub-type, or a different node type/sub-type in the same network. Each node type/sub-type can be linked through a chain of nodes and linkages consisting of different node types/sub-types and linkage types to another node of the same or different node type/sub-type. The type or types of links which can exist between two nodes depends on the node type/sub-type of the nodes to be linked and can represent the types of relationships which can exist between the node types/sub-types to be linked (see FIG. 4). The links between the two nodes to be connected may be asymmetric. An asymmetric link is one that can have a forward and reverse or inverse value which is different e.g. mother/daughter; pet/owner.

Thus nodes 30 are linked by linkages 32 with a defined linkage type. Nodes can be linked by more than one linkage type, representing the multiple types of relationships between the entities represented by the nodes. Each linkage type represents the actual relationship type which exists between a node and any other node type. A linkage of a person node to an object node can be, for example, customer, fan, owner, admirer, member and the like. A linkage of a person node to another person node can be, for example: mother/daughter, best friend, biological, social, or genetic. A linkage of a person node to an animal node can be owner/pet, admirer, etc. A linkage of a person node to a place node can be visitor, resident, fan, etc. Nodes are thus linked by precise linkage types representing the actual type relationship which exists between the person, place, object or animal represented by the linked nodes.

FIG. 4 illustrates a matrix of linkage relationships. Row and column 40 represent different node types/sub-types. For each pair of node types and/or sub-types 40 (for example, living male person 1a3 to living female person 4a1, living female person 4a1 to pet/cat 2a2, etc.) there will be a set of linkages L, 42 consisting of multiple linkage types. For example two person nodes can be linked with the linkage types father/daughter, friend/friend, employer/employee etc. A person node 1a2 can be linked to a pet node 3a3 by a link with linkage type owner/pet, friend, admirer etc. (L18f and L18r). A person/object relationship can be owner, member etc. As illustrated in FIG. 4, where the relationship is asymmetric, there will be two types of linkages r and f depending on the direction of the linkage between the two nodes, one being the inverse (reverse r) of the other (forward f). For example pet/owner, mother/son and father/daughter are such asymmetric relationships. A linkage may thus have reciprocal relationship types and be bidirectional e.g. node 1 to node 2 and node 2 to node 1. The relationship of node 1 to node 2 may not be the same as the relationship of node 2 to node 1. For example, the linkage type of a person node to a dog node may be owner while the linkage type of the same dog node to the person node may be pet.

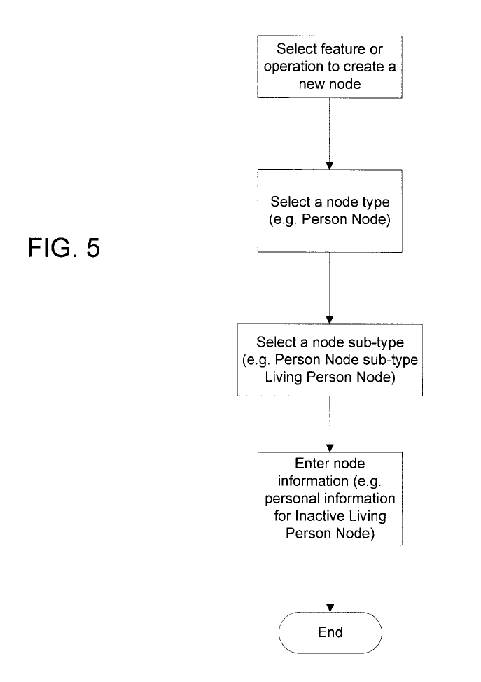

FIG. 5 illustrates the steps when a user creates a new node. The user selects the feature from his/her control panel to create a new node. The user selects a node type for the new node such as person, place, object or animal. Next the user selects a node sub-type from a menu provided for that node type, or by entering an acceptable sub-type (e.g. for a person node—living or deceased; for an animal node—pet/livestock; for an object node—organization/product etc.). Next, the user selects a further node sub-type from a menu provided for that node sub-type, or by entering an acceptable sub-type (e.g. for a node type person with a sub-type living, the further sub-type choice can be active or inactive etc.). Further levels of sub-type in the hierarchy can be specified. Node information is then entered to complete the node such as name, description etc.

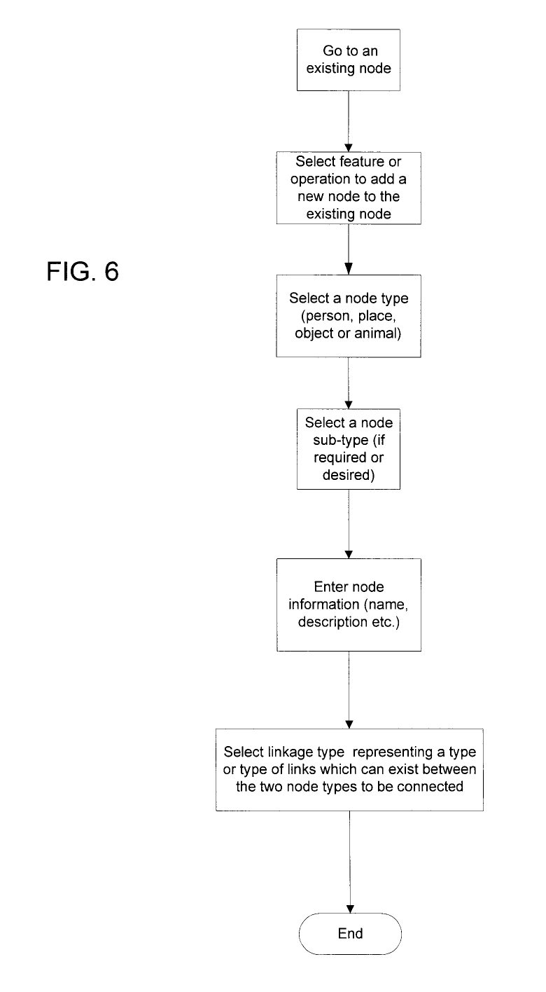

FIG. 6 illustrates the steps in creating a new node and linking it to an existing node. The user goes to an existing node 30 (which need not be the user's node 31). The user selects the feature from the node's control panel to create a new node. The user selects a node type for the new node such as person, place, object or animal. Next, if desired, the user selects a node sub-type from a menu provided for that node type, or by entering an acceptable sub-type (e.g. for a person node—living or deceased, for an animal node—pet/livestock, for an object node—organization/product etc.). Next the user selects a further node sub-type from a menu provided for that node sub-type, or by entering an acceptable sub-type (e.g. for a node type person with a sub-type living, the further sub-type choice can be active or inactive etc.). Further levels of sub-type in the hierarchy can be specified. Node information is then entered to complete the node such as name, description etc. Next the user selects the linkage type to define the relationship between the two nodes to be linked from a menu which provides the set of linkages L which can exist between the two nodes, as shown in FIG. 4, or by entering an acceptable linkage (e.g. father/daughter, pet/owner etc.).

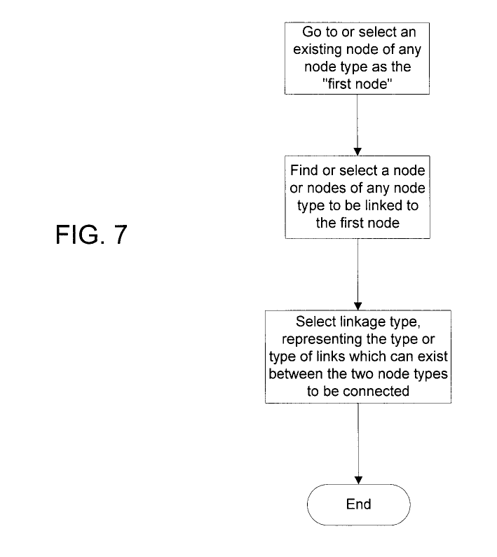

FIG. 7 illustrates the steps in linking two existing nodes. The user goes to or selects the first existing node of any type or sub-type by clicking on the node, identifying its unique identifier, or by searching and selecting from keyword identifiers or other search terms. Next the user selects the node to be linked, which can be any type or sub-type, by clicking on it, identifying its unique identifier, or by searching for and selecting from keyword identifiers or other search terms. Next the user selects the linkage type to define the relationship between the nodes to be linked from a menu which provides the set of linkages L which can exist between the two nodes, as shown in FIG. 4, or by entering an acceptable linkage type (e.g. father/daughter, pet/owner etc.).

Users who have registered with the system are “active” while individual persons whose nodes form part of a network of living and non-living entities but have not registered with the system are “inactive”. An “active” node is one whose associated user has registered with the system, and who is alive. It contains the home page and information pertaining to the user represented by the node, as well as a control panel accessible to the living individual person that it represents. Nodes which are not “active” are either designated as “potentially-active” or “inactive”. A “potentially-active” node is one whose associated entity is a live person or organization of persons but who has not registered with the system, and an “inactive” node is one whose associated user is deceased or which represents an entity other than a living person or organization of living persons. The effect of these designations is discussed further below. A potentially-active node contains the data and tools associated with the potentially-active node, a control panel and all other associated features of the potentially-active node. An “inactive” node contains a home page as described below and a control panel for other living users to edit the node.

While an “inactive” node will always remain so (unless the designation was made in error), a “potentially-active” node becomes “active” once the living individual person that it represents joins the system through registration as described further below. An active node becomes inactive when the associated individual person that it represents dies. These designations affect how the information connected with the node can be modified, and how communications are made between nodes. Thus the system designates nodes 30 as active, potentially-active, or inactive. Living persons or organizations of persons can represent themselves to other persons or organizations of persons through their active nodes and interact electronically with other persons or organizations of persons represented by an active node.

An inactive node can contain information pertaining to the entity that it represents, a home page, communication tools, data and files, storage space, and tools to allow one or more living individual persons to view, add, edit, or delete information pertaining to the entity that it represents, such as by clicking on a link which takes the individual person to a control panel. The control panel of the inactive node allows one or more living individual persons to independently add, edit, or delete information for the same inactive node, such as by clicking on a link to go to an editing page. The identity of the contributor is automatically recorded. All contributions and contributors to the same entity's home page can be viewed from the entity's node. The inactive node can also contain communication tools which allow living individual persons to exchange information pertaining to the entity that it represents.

A potentially-active node can contain information pertaining to the living individual person or organization of persons that it represents, home page, communication tools, data and files, storage space, and tools to allow one or more living individual persons to view, add, edit, or delete information pertaining to the individual person that it represents. The potentially-active node can also contain invitation tools which allow other individual persons to invite the individual person or organization of persons represented by the potentially-active node to register with the system and thereby change the potentially-active node to active.

The network of living and non-living entities as shown in FIG. 2 is thus created by the addition and linkage of a node to one or more other additional nodes, or by uploading a file. The linkage can have one or more defined linkage types representing different relationship types. Nodes are thus linked by precise linkage types representing the actual relationship type which exists between the person, place, object or animal represented by the linked nodes. An individual person's node may occupy more than one position in the same network. For example an individual person's node may be linked to the network as both a friend of one node and a co-worker of another node in the same network. The relationship of a node to another node within the same network of living and non-living entities can also be represented by more than one defined linkage type. For example an individual person may be a spouse of another individual person in the network as well as a co-worker.

A living individual person with an active node can view the connection, one or a series of defined linkages of nodes, between its own node and any other node in the network of living and non-living entities. The user can determine the linkage and view the connection between the user's node 31 and another node 30, as shown in FIG. 2, by clicking on a hyperlink or from a home page, such as by clicking on a link, and from which the user can view a chain showing the precise connection between any two nodes. The network of living and non-living entities 24 can be viewed directly from the home page associated with the node or from the control panel of the viewer.

The network of living and non-living entities 24 can be viewed in many ways, such as graphically as a set of nodes 30 connected by their associated linkages 32, or as a list. The network of living and non-living entities can be presented graphically by setting a single node as the root of the network of living and non-living entities and displaying a set number of linkages 32 radiating from the root node. Another part of the network of living and non-living entities can be viewed by resetting another node as the root. This can be done by entering that node's username or identifier, or by clicking on a link from the node of interest. When the network of living and non-living entities 24 is viewed from a node or its associated control panel, the entity represented by the node or control panel is set as the original root. When a viewer navigates the network of living and non-living entities away from the original root, the path back to the original root is displayed. The network of living and non-living entities for any individual entity can be viewed by viewing the individual entity's node.

Nodes, linkages, linkage types, and all data pertaining to the network can be categorized, sorted and stored in the same database which forms part of the system and retrievable from the same system. Data is categorized and has a common structure within the same node type.

Instead of being constructed by an active user, a network of living and non-living entities can be created or contributed by a user who is not a member of that network of living and non-living entities, or by a user who is not registered with the system, such as by uploading a file such as a GEDCOM file, or by the system managers. Thus one or more nodes in the network can be created by an entity other than a user with an active node. Any number of nodes and linkages can be created independently and added to the network.

### Editing the Network of Living and Non-Living Entities

The network of living and non-living entities can be edited by living individual persons who are represented by active nodes within the same network of living and non-living entities or another network or outside the network of living and non-living entities in the system. An inactive node can be edited by one or more living individual persons such as ones who are represented by an active node. For example, person nodes 33 or animal nodes 39 can be edited by editing the facts, records, life story or other information about an individual person or animal, or by altering whether they are living or deceased, or by leaving a testimonial, adding photos or other information. A node for a place 35 can be edited by adding testimonials, stories etc. about the place. A node for an object 37 can be edited by adding details of the object such as location, price, specifications etc.

A potentially-active node can also be edited by one or more living individual persons or organizations of persons who are represented by an active node 36. An active node 36 can be edited by the same living individual person or organizations of persons represented by the node. The active node can also be edited by one or more other living individual persons or organizations of persons who are represented by another active node 36, such as by leaving a testimonial, adding photos or other feedback, provided permission is obtained as described below.

The network of living and non-living entities can also be edited by adding new nodes to the network of living and non-living entities 24, and by adding or modifying a series of linkages 32 between the existing nodes in the network of living and non-living entities 24. The network of living and non-living entities can be edited by changing the linkage type of an existing linkage in the network of living and non-living entities or by deleting a linkage. The permission for a living individual person or organizations of persons who is represented by an active node to add, edit or delete a node in the network of living and non-living entities is defined by the relationship of the editing user's node to the node to be edited as well as relationship to all other active nodes within the same network of living and non-living entities who will be affected by the addition. The permission for a living individual person or organizations of persons who is represented by an active node to edit a linkage 32 in the network of living and non-living entities 24 can be defined by living individual persons or organizations of persons who will be affected by the edit. The right of a user to edit the network is dependent on the location of the node to be edited relative to the user's node and any other active nodes affected by the edit between the edited node and the user's node. The network of living and non-living entities 24 can also be edited by adding new data to a node 30 within the network of living and non-living entities, such as by changing or deleting existing data connected with the node, or by changing the node type. For example, an “active” designation for a node can be converted to a “potentially-active” designation. An “active” designation for a node can also be converted to an “inactive” designation, for example once the individual person that it represents becomes deceased. A “potentially-active” designation for a node can also be converted to an “inactive” designation once the individual person that it represents becomes deceased. An inactive designation for a node can also be converted to a “potentially-active” designation to make a correction, and a “potentially-active” designation for a node can also be converted to an “active” designation as discussed below.

Once a node becomes active, the persons or organization of persons represented by the node can add to the network of living and non-living entities 24 by creating new nodes 30 for entities that he/she would like to add to the network of living and non-living entities and linking the nodes to existing nodes in the network of living and non-living entities through defined relationships, thus growing the network of living and non-living entities. Individual persons with active nodes can edit the network of living and non-living entities by editing other potentially-active or inactive nodes in the network, and can seek to expand the network of living and non-living entities by inviting individual persons who are represented by a potentially-active node within the network of living and non-living entities to join the network of living and non-living entities by registering and activating their corresponding node.

An individual person or organization of persons with an active node can seek to enlarge the network of living and non-living entities by sending an invitation to individual persons or organizations of persons with potentially-active nodes within the network of living and non-living entities to join the network of living and non-living entities and change their potentially-active status into active status. An individual person or organization of persons with an active node can identify individual persons or organizations of persons with potentially-active nodes within the same network of living and non-living entities and send an invitation to the individual person or organization of persons represented by a potentially-active node to register with the system and become represented by an active node in the network of living and non-living entities. For example, after a user creates a node for a person in the network of living and non-living entities, the user may invite the new potentially-active entry to join the system. By clicking on a link associated with the node of the individual person in question, the user is taken to a page which invites the user to enter the email address of the entity represented by a potentially-active node in the network of living and non-living entities and optionally include a personal message. The user then clicks on a link to send the message and the system composes and sends an email invitation to the email address provided. The recipient of the email may accept the invitation by clicking on a hyperlink which takes the recipient to a page to enter the registration details and register the recipient in the system, at which point the node associated with the individual person becomes designated as “active”. Of course, the potentially-active individual person can also be invited to join the network by telephone, postal mail, verbally in person, by internal messaging systems, etc. The potentially-active node may become active once the individual person that it represents accesses the system and registers, or registers independently of any invitation.

Separate networks of living and non-living entities can be merged into one. An individual person with an active node can invite individual persons with an active node from another network of living and non-living entities to join his/her network of living and non-living entities and merge the two networks of living and non-living entities into one. Also, an individual person with an active node can edit the network of living and non-living entities by adding a node of any type from another network of living and non-living entities and thereby merge the two networks of living and non-living entities into one. When two networks of living and non-living entities both include nodes representing the same entity, an overlap is detected and a series of questions will be put to the user seeking to add the entity's node to his/her network of living and non-living entities in order to confirm the overlap. If the node is found to overlap two networks, then permissions will be sought to merge the two networks. Permission to edit the network of living and non-living entities by merging with another network of living and non-living entities is required from living individual persons or organizations of persons who are represented by active nodes in both network of living and non-living entities who will be affected by the merge, or from individuals who are responsible for the nodes affected by the merge. For example, an individual may be identified in the system as responsible for a node other than a person node, such as a pet node. In a situation where nodes from separate networks of living and non-living entities occupy the same position in the merged network, an analysis in the form of a set of questions will be asked to determine whether the two nodes represent the same entity. If they do represent the same entity, then the separate nodes will be merged into one and the associated data will also be merged.

### Communication Between Nodes

The interaction of an individual person or organization of persons who is represented by an active node within a network of living and non-living entities with another individual person or organization of persons who is represented by an active node within the same or another network of living and non-living entities is facilitated by the social networking features of the network of living and non-living entities. The social networking features of the network of living and non-living entities facilitate many forms of communication, such as notification of updates, alerts, sharing of files and photos, blogs, instant messaging and comments. Also, the sender can select those in the network of living and non-living entities who can receive or view a particular communication or file. An electronic message can be sent by regular email or by clicking on a hyperlink which takes the user to a page which permits an electronic message to be composed to be addressed to the addressee's username. The interaction can be direct communication between individual persons, sharing of data, receiving data, editing data, notification of data updates within a node, transfer of data to another node, and addition of data to another node. The individual represented by an active node can join groups, organize memberships, send emails from the node, and the like and in particular take advantage of the activities facilitated by the social networking features of the network of living and non-living entities, such as using certain communication tools.

While the invention has been disclosed in its preferred embodiment as an online (Internet) method, the same method can be applied in an intranet, local or wide area computer network, or on a stand-alone computer system.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of constructing an interactive computerized network of living and non-living entities, comprising:
i) providing an interactive computer system comprising a database, said system accessible to one or more users;
ii) creating an interactive computerized network comprising a plurality of nodes, each node associated with a defined node type representing living and non-living entities, each node linked to one or more nodes of the same node type or a different node type by linkages; each linkage associated with a defined linkage type; each said linkage type representing the type of relationship which exists between the entities represented by the nodes that are linked, the linkages of nodes thereby forming a computerized network.

2. The method of claim 1 wherein said interactive computer system is selected from the group consisting of the Internet, online computer network, intranet, local area network, wide area network, and stand-alone computer system.

3. The method of claim 2 wherein said online interactive computer network comprises a social network.

4. The method of claim 1 wherein said one or more users are permitted to create, add to, delete, edit and modify said nodes and linkages.

5. The method of claim 1 wherein said node types are selected from the group consisting of person, place, object or animal.

6. The method of claim 1 wherein each said node type comprises a plurality of node sub-types.

7. The method of claim 6 wherein each said node sub-type comprises a plurality of further node sub-types.

8. The method of claim 7 wherein each said further node sub-type comprises a plurality of further node sub-types.

9. The method of claim 6 wherein a user creates a new node by accessing said interactive computer system, selecting a feature to create a new node, selecting a node type, and optionally selecting one or more than one node sub-types and entering information concerning said new node.

10. The method of claim 6 wherein a user creates a node and links it to an existing node by selecting an existing node in said computer network, selecting a feature to create a new node, selecting a node type for the new node, optionally selecting one or more node sub-types for the new node, entering information concerning said new node and selecting one or more than one linkage types representing a type of relationship which can exist between the entities represented by the existing node and said new node.

11. The method of claim 1 wherein a user links two existing nodes by selecting an existing node in said computer network, selecting a second existing node to be linked to said existing node, and selecting one or more than one linkage types representing a type of relationship which can exist between the entities represented by said two existing nodes.

12. The method of claim 6 wherein the network is created by one or more of said users creating a first node and one or more additional nodes, selecting node types for said first node and each of said one or more additional nodes, and optionally selecting one or more than one node sub-types for said first node and each of said one or more additional nodes and selecting a linkage type between said first node and said one or more additional nodes to form a computerized network.

13. The method of claim 6 wherein said node types or sub-types comprise living and non-living.

14. The method of claim 13 wherein said non-living node types or sub-types comprise deceased entities and entities that are not alive.

15. The method of claim 14 wherein a living node type or sub-type represents a living organism and a deceased node type or sub-type represents a deceased organism.

16. The method of claim 6 wherein said node types or node sub-types comprise pets.

17. The method of claim 1 wherein each node contains information pertaining to the living or non-living entity that it represents.

18. The method of claim 1 wherein each node is associated with a unique identification.

19. The method of claim 5 wherein an individual person, animal, object, organization or place with any defined node type in the network can be connected to another individual person, animal, object, organization or place with the same or different node type in the same network.

20. The method of claim 1 wherein any node is connected to any other node by a single linkage or by more than one linkage between the two nodes.

21. The method of claim 1 wherein a node is connected indirectly to another node through a chain of one or more nodes and linkages which exist between the two separate nodes which serve to connect the two separate nodes in a connected chain, such chain simultaneously containing the same or different node types and the same or different linkage types.

22. The method of claim 21 wherein any two nodes in the network can be connected by one or more than one different chain.

23. The method of claim 1 wherein each said linkage is associated with one or more than one defined linkage types.

24. The method of claim 5 wherein the linkage type represents the actual type of relationship or association which exists between the person, place, object or animal represented by the nodes that are linked.

25. The method of claim 1 wherein there are multiple different linkage types each representing a different relationship type.

26. The method of claim 25 wherein the linkage of a node with the another node having the same or different node type is selected from a set of linkage types which represent the types of relationships which can exist between the entities represented by the combination of node types connected by said linkage.

27. The method of claim 25 wherein said type of relationship comprise asymmetric relationship types, and the linkage between two nodes thereby has two reciprocal relationship types.

28. The method of claim 6 wherein the linkage types between nodes having a person type or sub-type and nodes having an animal type or sub-type comprises owner and pet.

29. The method of claim 1 wherein one of said users registers with the system and is assigned a first node with a unique identification and comprising the further step of permitting said user to create a plurality of additional nodes, each representing a person, place, object, or animal, each said additional node linked to said first node or said additional nodes by a linkage with a defined linkage type representing the relationship type which exists between the linked nodes.

30. The method of claim 1 wherein one of said users registers with the system and is assigned a first node with a unique identification and comprising the further step of permitting said first node to link to existing nodes in the system, each said node linked to said first node by a linkage with a defined linkage type representing the relationship type which exists between the linked nodes.

31. The method of claim 1 wherein said network is created through the linkage of a node of any type to one or more separate nodes of any type in the same network.

32. The method of claim 1 wherein each said node has defined properties and features.

33. The method of claim 6 wherein each said node having a node type or sub-type has defined properties and features specific to said node type or sub-type.

34. The method of claim 1 wherein a node is associated with information pertaining to the living or non-living entity that it represents.

35. The method of claim 1 wherein a node is associated with one or more than one tools selected from the group comprising communication tools, tools for editing the same node, and tools for constructing and editing the network of living and non-living entities.

36. The method of claim 1 wherein the network facilitates the communication between a node with any other node in the network and such communication consists of sharing of information, contributing information, and storage of information.

37. The method of claim 1 wherein the nodes interact with each other and with living individual persons in the network using the social networking features of the network.

38. The method of claim 37 wherein said interaction is selected from the group consisting of direct communication between individual persons, sharing of data, receiving data, editing data, copying data, analyzing data, notification of data updates within a node, transfer of data to another node, and addition of data to another node.

39. The method of claim 1 wherein nodes are designated as active, potentially-active, or inactive.

40. The method of claim 39 wherein an individual person with an active node in the network can interact with other living individual persons with an active node in the network using the social networking features of the network.

41. The method of claim 39 wherein an active node allows the living individual person that it represents to access means for constructing or editing a network, communicating with other nodes through the social networking features of the network, sending an invitation to individual persons represented by potentially-active nodes to become active nodes, accepting invitations from other nodes, granting permission to another individual person to edit the network or carry out activities using the social networking features of the network.

42. The method of claim 39 wherein the right of a user to edit the network is defined by whether the user's node is designated as active, potentially-active, or inactive.

43. The method of claim 1 wherein the right of a user to edit the network is dependent on the relationship of the node to be edited relative to the user's node and the relationship of the node to be edited to any other nodes affected by the edit.

44. The method of claim 39 wherein a node can be converted from active to inactive and from potentially-active to active and from active to potentially-active and from potentially-active to inactive.

45. The method of claim 39 wherein an active node or potentially-active node representing a living person is converted to an inactive node once the person that it represents becomes deceased.

46. The method of claim 39 wherein a potentially-active node representing a living person is converted to an active node once the person that it represents registers with the computer system.

47. The method of claim 39 wherein nodes designated as active, potentially-active, or inactive all co-exist within the same network.

48. The method of claim 1 wherein the network, nodes in the network, linkages and associated information can be created, added, edited and deleted by uploading a file.

49. The method of claim 1 wherein the network, nodes in the network, linkages and associated information can be created, added, edited and deleted by one of said users.

50. The method of claim 1 wherein the network, nodes in the network, linkages and associated information can be created, added, edited and deleted by a person other than one of said users.

51. The method of claim 1 wherein one of said users or a person other than one of said users can view the connection, one or a series of defined linkages of nodes, between its own node and any other node in the network of living and non-living entities.

52. The method of claim 1 wherein the network of living and non-living entities can be viewed directly from the home page associated with the node or from the control panel of the viewer.

53. The method of claim 1 wherein the network of living and non-living entities can be viewed graphically as a set of nodes connected by their associated linkages or as a list.

54. The method of claim 1 wherein the network of living and non-living entities can be presented graphically by setting a single node as the root of the network of living and non-living entities and displaying a set number of linkages radiating from the root node.

55. The method of claim 1 wherein two or more separate networks of living and non-living entities are merged into one network of living and non-living entities.

56. The method of claim 55 wherein separate networks of living and non-living entities are merged into one network of living and non-living entities when an individual person with an active node invites individual persons with an active node from another network of living and non-living entities to join his/her network of living and non-living entities and merge the two networks of living and non-living entities into one.

57. The method of claim 55 wherein separate networks of living and non-living entities are merged into one network of living and non-living entities when an individual person with an active node edits the network of living and non-living entities by adding a node of any type from another network of living and non-living entities and thereby merging the two networks of living and non-living entities into one.

58. The method of claim 55 wherein separate networks of living and non-living entities are merged into one when two networks of living and non-living entities both include nodes representing the same entity.

59. The method of claim 55 wherein when it is detected that two networks of living and non-living entities both include nodes representing the same entity, permissions are sought to merge said two networks of living and non-living entities from living individual persons or organizations of persons who are represented by active nodes in both network of living and non-living entities who will be affected by the merge, or from individuals who are responsible for the nodes affected by the merge.

60. The method of claim 55 wherein nodes from separate networks of living and non-living entities occupy the same position in the merged network, an analysis is made to determine whether the two nodes represent the same entity, and if they do represent the same entity, then the separate nodes are merged into one.

61. A computer system for constructing an online interactive computerized network of living and non-living entities, the system comprising:
i) website and database maintained by a server accessible online to a plurality of users;
ii) computer-implemented means for creating an interactive computerized network comprising a plurality of nodes, each node associated with a defined node type representing living and non-living entities, each node linked to one or more nodes of the same node type or a different node type by linkages; each linkage associated with a defined linkage type; each said linkage type representing the type of relationship which exists between the entities represented by the nodes that are linked, the linkages of nodes thereby forming a computerized network.

62. A computer program product comprising a memory having stored therein computer-executable instructions that when executed by a computer carry out the method of claim 1.
